(19) United States
(12) Patent Application Publication
(10) Pub. No.: US 2003/0093316 A1
(43) Pub. Date: May 15, 2003

(54) Method and system for generating a custom web page from a URL suffix

(76) Inventors: John Wirth JR., Dubois, WY (US); Todd C. Nelson, Conifer, CO (US)

Correspondence Address: NIXON & VANDERHYE, PC, 1100 N GLEBE ROAD, 8TH FLOOR, ARLINGTON, VA, 22201-4714, US

(21) Appl. No.: 10/277,162

(22) Filed: Oct. 22, 2002

Related U.S. Application Data
(63) Continuation-in-part of application No. 09/987,438, filed on Nov. 14, 2001.

(51) Int. Cl. G06F 17/60

(52) U.S. Cl. 705/14

(57) ABSTRACT

A method and system for obtaining orders from customers on an e-commerce website. A mailing list of potential customers having a particular interest is chosen, and then obtained through a purchase or lease arrangement. The list is then screened to eliminate duplicate names and names of persons not meeting certain other criteria. First and last names from the screened mailing list are stored in a website server. The screened list is also mailed to the potential customers using postcards chosen for high visibility and contrast with the information printed on the postcards. The names and mailing addresses are printed on the front of the postcards, while on the back of the postcards is printed the website's URL concatenated with corresponding first and last names of the potential customers and an offer designed to induce the addressees to log onto the website and place an order. A program on the server seeks to match the login names with the stored names. If a login name is matched with a stored name, a special promotional offer page is to presented to the person logging onto the website.

### FIELD OF THE INVENTION

The present invention relates to Internet websites, and, in particular, to a method and system for generating a custom web page from a URL suffix that is used to induce a customer to place an order on an e-commerce website.

### BACKGROUND OF THE INVENTION

The Internet is a global communications system in which a vast number of computers and other devices are networked to allow user-to-user communications and transfers of data files from one machine to any other on the network. The World Wide Web serves as one type of interface to the Internet that allows users to readily navigate the Internet's vast resources. The Web allows information and data dispersed across the Internet to be linked in an easily accessible way.

The World Wide Web uses a client/server architecture in which client programs, called web browsers, running on users' computers request data from server programs running on other computers, called servers, located elsewhere on the Internet. The data requested by a user's browser is typically part of a website maintained by a company or other entity. When the browser program requests the data, a web server hosting the website sends the requested data back over the Internet to the browser, which then interprets and displays the data on the user's computer screen. Thus, a web browser is a computer program or application that has the ability to request data from any server on the Internet and interpret and display on a user's computer the data sent by a server through the Internet. Conversely, a web server is a computer programmed to respond to web browser requests for data and that sends the requested data to the web browser through the Internet.

A web page is typically a file that contains HTML (hypertext markup language) files containing text and graphics, along with a set of HTML tags that describe how the text and graphics should be formatted and displayed on a user's computer screen. The tags are instructions that tell the web browser how the page should look when it displays the page on a user's computer. So, for example, the tags serve to change the font size or color, arrange things in columns, etc. The graphics or images on web pages are often GIF files or JPG files. The GIF files are generally used for drawn graphics, while the JPG files are generally used for photographs or scanned images.

The World Wide Web uses an addressing system known as a Uniform Resource Locator (URL). A URL consists of four parts that, when combined, completely define the location of any file or service located anywhere on the Internet. These parts are the protocol, domain name, path, and filename. Thus, a user's browser, in requesting a web page from a website, sends a message over the Internet that includes at least a transfer protocol (e.g., http://), and a domain name (e.g., www.companyname.com). The last two components of a URL may or may not exist, depending on the location and type of information any given hyperlink points to. They are typically preceded by a “/” and referred to as a suffix to the domain name. The server receives the user's request and retrieves the requested web page or other file, which is composed in HTML. The server then transmits the requested page or other file back across the Internet to the user's computer. The user's browser program receives the HTML file and displays its interpretation of the requested file. Thus, browser programs send requests and receive the data needed to display the HTML page on a user's screen. This includes the HTML file itself, plus each of the graphic, sound and video files mentioned in the HTML file. Once the data is retrieved, the browser formats the data as indicated by the HTML tags and displays it on the user's computer screen.

Web pages are typically hypertext documents, i.e., documents which provide clearly visible links to other documents or web pages on the World Wide Web. When a user clicks on a hypertext link, or hyperlink, a new request to retrieve another file is sent over the Internet. With a web browser, a user typically sees formatted documents that contain text, graphics and highlighted hyperlinks.

The browsers let a user navigate the Internet, not by entering commands, but rather by moving a mouse pointer to a desired hyperlink and clicking. The browser establishes contact with the related server in a remote computer, and the server transfers the requested file to the user's machine, displaying it in the user's browser as another formatted, hyperlink document. Thus, a user can “surf” the web by hopping from hyperlink to hyperlink without delving deeply into the contents of any particular document.

Because the Internet contains vast amounts of information that is accessible by persons browsing the Internet using their personal computers, many people use the Internet to search for specific information. Others, however, simply surf the Internet on a “hit or miss” basis looking for websites and information of interest. Often such persons will stumble upon a website which interests them enough to “bookmark” the site for easy future access. Because of the large numbers of websites and the vast amount of information available on the Internet, it can be difficult to “attract” persons to a particular Internet website.

The Internet has also become a vehicle for electronic commerce through which companies sell products and services to the public via websites. Typically, potential customers will visit a company's website and browse a product catalog or other information presented on the website. In such a situation, it is particularly desirable to attract as many potential customers to a website as possible to increase the likelihood of selling products or services offered through the website. While a company can list its website with search services available on the Internet, this alone may not be sufficient enough to attract potential customers to the website.

One company seeking to attract potential customers to its website mailed the customers fortune cookies containing a “fortune” that identified the company's website and a promotional offer from the company. When the customer logged onto the company's website, he or she was transferred to a URL site that described the company's promotional offer. The same URL site was used for every customer who received a fortune cookie mailer and who logged onto the company's website, irrespective of the customer's name.

### SUMMARY OF THE INVENTION

The present invention relates to inducing potential customers to log into an Internet website and place an order. Typically, for this purpose mailing lists of potential customers known to have a particular interest are obtained. Often, the mailing lists are obtained through a purchase or lease arrangement from companies in the business of compiling mailing lists. The lists are then screened to eliminate duplicate names and other undesirable names. The screening results in a revised mailing list of names and addresses that are loaded into a website server. Each of the names and addresses is then printed on a postcard with an offer that is calculated to induce the addressee to visit the website and a URL where the offer can be viewed. The postcards are then mailed to the addressees. Alternatively, e-mail addresses of potential customers with a particular interest are obtained. Here again, the e-mail lists are obtained from companies in the business of compiling such lists. The e-mails are then sent to the customers with an offer that is again calculated to induce the e-mail recipient to click on a hyperlink in the e-mail that causes him to visit the website and the URL where the offer can be viewed. A program on the website web server seeks to match the names of persons logging into the website with the mailing list and/or e-mail list names stored in the server. If a login name is matched with a stored name, a special personalized promotional offer page is presented on the website to the customer. The personalized promotional offer identified on the mailer is intended to reflect the particular interests of the customer logging onto the page so as to induce the customer to visit the website.

One difficulty arises when the number of addresses and/or e-mail recipients reaches a very high level, such as in the hundreds of thousands. Managing hundreds of thousands of custom web pages would require a large amount of management overhead. The management overhead would require a large number of people involved in maintaining the custom web pages, that is, keeping the content of the web pages relevant and up-to-date, with current prices, product listings, descriptions, inventory levels, etc. Every time a company made a price change, all of the affected pages would require updating. Every time a company added or removed a product, again, all of the affected pages would require updating.

Generally, persons “surf” the Internet by typing different URL addresses into their computers. The URL addresses often corresponds to the home web page of a particular website. A given URL often can also include a name or number to the right of the URL website that is called a “suffix”. Traditionally, web servers handle such an extended address as a whole URL so that the web server looks for a corresponding piece of data that resides on the server, and serves up the information that corresponds to the URL suffix to the right of the domain name address. Thus, for example, if the URL typed is www.companyname.com/home.htm, the suffix is everything to the right of the slash at the end of companyname.com, i.e., home.htm. Home.htm refers to a page that resides on the companyname.com server and that instructs the server to deliver the contents of that page over the Internet to the person requesting such information using his web browser. When a requested page does not actually exist, a web server will typically respond with an error message.

The method and system of the present invention takes advantage of the error process for responding to a non-existent web page requested by a URL suffix by generating a custom response that is a custom web page keyed to the suffix. According to the present invention, when a website URL with a name or number to the right of the slash is received by a web server, if no corresponding web page exists, instead of creating an error message and returning an error to a customer, the present invention creates a custom web page in response to receipt of the suffix name or number. The custom web page typically includes an offer or promotion that is geared to inducing the customer to visit and place an order on the website. According to the method of the present invention, a postcard, e-mail or other vehicle of merchandising is sent to a potential customer bearing a website address such as www.companyname.com/johndoe. It is expected that a potential customer named “John Doe” who receives the postcard mailing or e-mail will be intrigued as to why his name is present in the postcard or e-mail. To satisfy his curiosity, the customer will typically type in or click on the URL contained in the postcard or e-mail to view the offer or promotion mentioned on the postcard or in the e-mail. When the web server receives the URL, there is no page sitting in the server to respond to the “johndoe” suffix. Instead of responding to the URL with an error message, the server is programmed to read the URL suffix and determine whether its data base includes data corresponding to the URL suffix. The data may indicate that a corresponding postcard or e-mail has been generated and sent to a potential customer. If it has, the server is programmed to then build a special web page that addresses the “johndoe” URL suffix, and, in most cases, expands on the offer to the potential customer of a deal, a promotion, or some other incentive to buy.

When the “johndoe” suffix URL is typed in, the server looks in a data base, which is located online, that is a list of all current postcards that have been mailed or e-mails that have been sent with promotional suffixes. If the particular suffix is included in a list, then the server responds with a promotional offer limited by whatever constraints are present in the data base for that particular URL suffix. The server might generate a web page that offers a 10% discount on a certain product line. If the server does not recognize the suffix as being in its data base, at the very least, it will generate a response that says “Hello, John Doe” and “Welcome to the companyname website.”

The method and system of the present invention can also be used as a tool to achieve low web page management overhead. The URL suffix can be used to build on the fly “virtual web pages”, i.e., pages that look and act like an actual web page, but that do not really exist. The method and system of the present invention can be used to create virtual web pages that search engines “spider” to determine the content of the web page for ranking the web page based on how good the quality of the content and how relevant the content is so that it is placed at the top of search engine listings for web pages identified in response to an Internet search request for a selected topic.

### BRIEF DESCRIPTION OF THE DRAWINGS

FIG. 1 is a flow diagram of a method for inducing potential customers to visit a website and place an order.

FIG. 2 is a block diagram of a system for carrying out the order obtaining method shown in FIG. 1 and the method of the present invention of generating a custom web page in response to a URL suffix.

FIG. 3A is a front view of a promotional postcard used with the present invention.

FIG. 3B is a back view of the postcard used with the present invention.

FIG. 4 is one embodiment of a webpage including a personalized promotional offer.

FIG. 5 is a flow chart for the method of the present invention of building a custom web page in response to a URL suffix.

FIG. 6 is one embodiment of a promotional e-mail used with the present invention.

FIG. 7 is another embodiment of a web page including a personalized promotional offer.

### DESCRIPTION OF THE PREFERRED EMBODIMENT

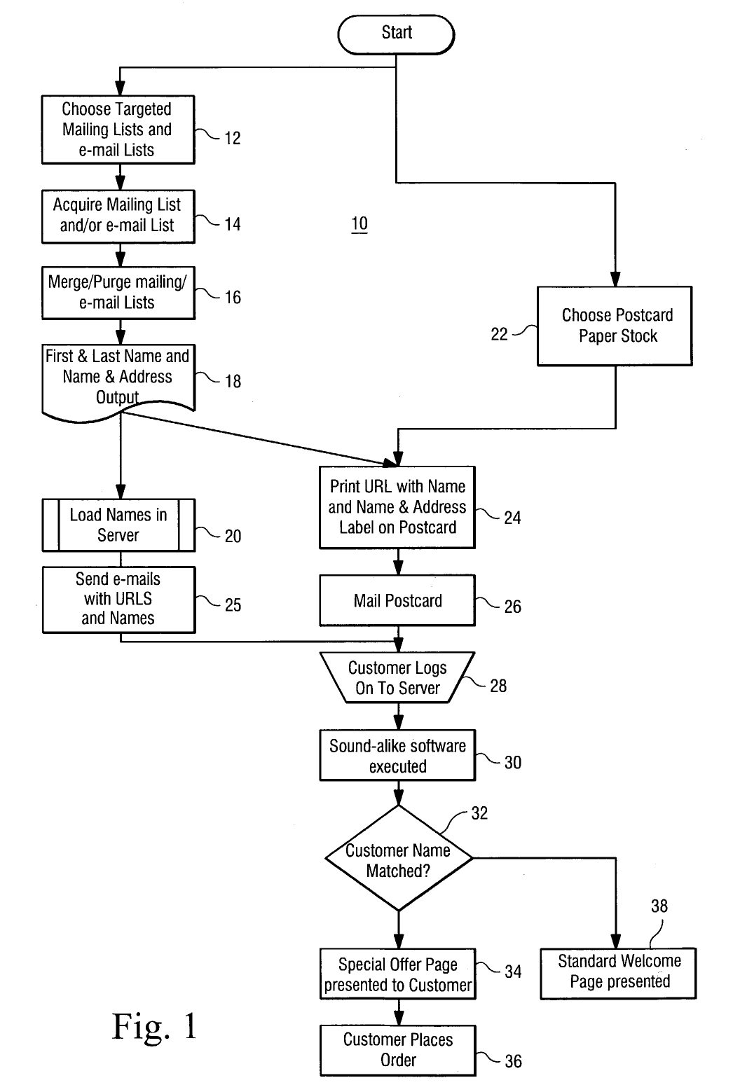

The present invention relates to inducing recipients of a mailing to login into a website and place an order at that website, and in particular to a method and system for generating a custom web page from a URL suffix. FIG. 1 is a flow diagram of an order obtaining method 10 used with the present invention. The first step 12 in the method 10 is to select one or more mailing lists and/or email lists of potential customers with a particular interest. The mailing and/or e-mail lists are chosen to provide relatively high response levels, and, thus, their selection is based on certain criteria, such as the income level or purchasing history of the potential customers. Once a mailing list and/or e-mail list for a certain type of customer has been selected, the next step 14 is to obtain one or more mailing lists or e-mail lists for this type of customer. Considering a single mailing or e-mailing for purposes of describing the invention, the mailing list and/or e-mail list is obtained through a purchase or lease arrangement. As one skilled in the art will appreciate, there are numerous companies that compile lists of potential customers from various sources, and which offer these lists for purchase or leasing by a company wishing to do a mailing or e-mailing to the persons on the list. The same companies will often have additional information about the persons appearing on their lists, such as their age, income, interests and geographic locations. Once a list is obtained, the next step 16 is to screen the list to eliminate duplicate and other undesirable names. Preferably, this is done by passing the list through a commercially available merge-purge process which eliminates duplicate names on the list and provides various list hygiene functions precedent to mailing. At step 18 shown in FIG. 1, the commercial merge-purge process is modified to provide a first name and a last name of each addressee, in addition to the mailing name and address or e-mail address.

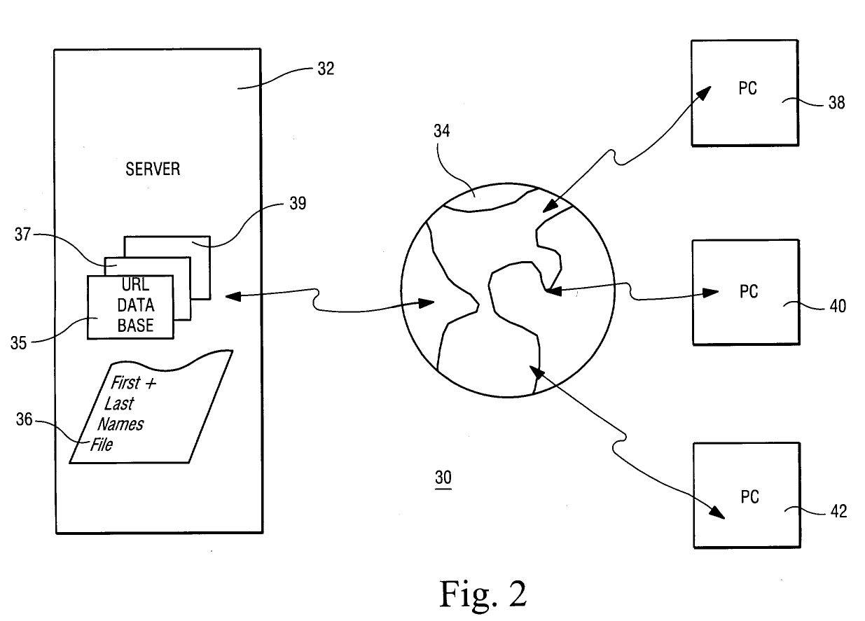

Referring now to FIG. 2, shown in that figure is a block diagram illustrating a system 30 for carrying out the method of the present invention. System 30 includes a computer server 32 connected to the Internet 34. Server 32's function it is to host one or more websites that are accessible from the Internet 34. Stored within server 32 is a file 36 that contains the first names and the last names that were obtained from the mailing list and/or e-mail list through the merge-purge process and that were stored in step 20 of the flow chart of FIG. 1 in the memory (not shown) of server 32.

Also shown in FIG. 2 are a series of client systems 38, 40 and 42, which can be televisions with Internet access, but which are preferably personal computers with a modem or other means (not shown) for connecting to the Internet 34. Stored in the memory of computers 38, 40 and 42 are browser programs for requesting information from web servers, such as server 32. The client systems 38, 40 and 42 are typically greater in number than the three systems shown in FIG. 2. They are typically operated by potential customers desiring to browse various websites accessible through the Internet.

Although not specifically shown in FIG. 2, server 32 and computers 38, 40 and 42 would each typically include a central processing unit (CPU) and a system bus that would couple various computer components to the CPU. This system bus may be any of several types of bus structures, including a memory bus or memory controller, a peripheral bus, and a local bus using any of a variety of bus architectures. The memory used by these computers would also typically include random access memory (RAM) and one or more hard disk drives that read from, and write to, (typically fixed) magnetic hard disks. A basic input/output system (BIOS), containing the basic routines that help to transfer information between components of a personal computer system, such as during start-up, may also be stored in read only memory (ROM). Server 32 and computers 38-42 might also include other types of drives for accessing other computer-readable media, such as a removable “floppy” disks, or an optical disk, such as a CD ROM. The hard disk, floppy disk, and optical disk drives are typically connected to a system bus by a hard disk drive interface, a floppy disk drive interface, and an optical drive interface, respectively. The drives and their associated computer-readable media provide nonvolatile storage of computer-readable instructions, data structures, program modules, and other data used by machines, such as these computers. These computers will also include a modem or other communication device for connecting to the Internet 34. Server 32 and computers 38-42 may also include other typical peripheral devices, such as printers, displays and keyboards. Typically, computer 38-42 would include a display monitor on which various websites are displayed.

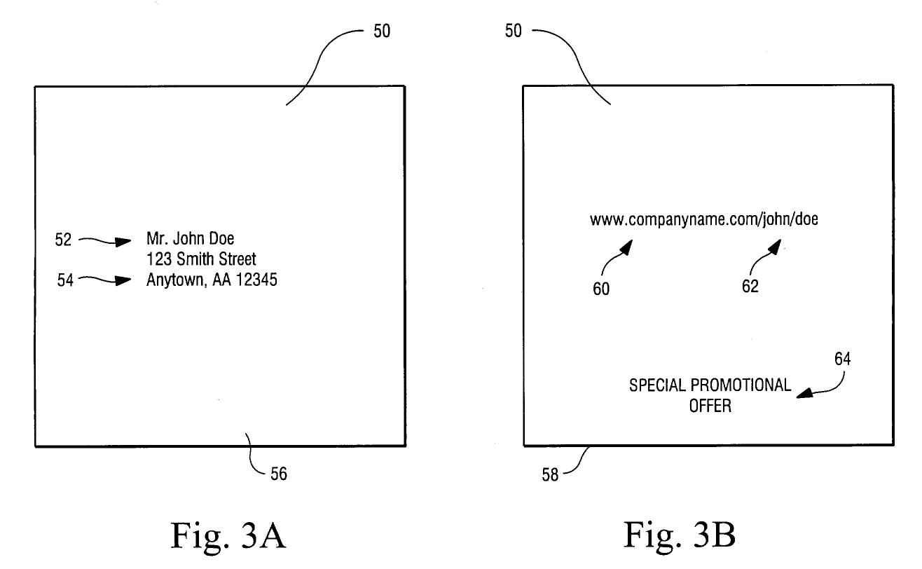

To send the mailing list obtained from the merge-purge process to potential customers, a suitable mailer is chosen that will get the attention of the recipients of the mailing. This mailer can be fliers or letters stuffed in an envelope addressed to the various recipients on the mailing list. Preferably, however, the mailer is a postcard 50 shown in FIGS. 3A and 3B, which has the advantages of being inexpensive to purchase and less expensive to mail than an envelope with a letter enclosed. Preferably, the postcard paper stock is chosen at step 22 of FIG. 1 for high visibility and contrast with the printed letters used in the mailing, which are typically black. Thus, for example, the postcard paper stock may be chosen to be a bright orange or pink color which would have a sharp contrast with the black lettering used for the mailing names and addresses. As described at step 24 of the flow diagram of FIG. 1, and as shown in FIG. 3A, the printing process consists of printing the mailing name 52 and address 54 of a given recipient on the front 56 of the postcard 50, while also printing on the back 58 of postcard 50 the target website's uniform resource locator (URL) 60 concatenated with the corresponding first and last name 62 appearing on the front of the postcard. Thus, by way of example, as shown in FIG. 3B the back of the postcard would have a printing as such:

www.companyname.com/john/doe or

www.companyname.com/johndoe

In the preferred embodiment of the invention, it is desirable to have the primary domain name represent an area of interest of the recipients of the mailing, such as by way of example, “woodworker”. This area of interest can be any area of interest, and typically the area of interest will influence the initial mailing list selection process. Once the postcards or other type of mailers have been printed, at step 26 of FIG. 1 they are mailed or otherwise sent to the potential customers listed on the mailing list.

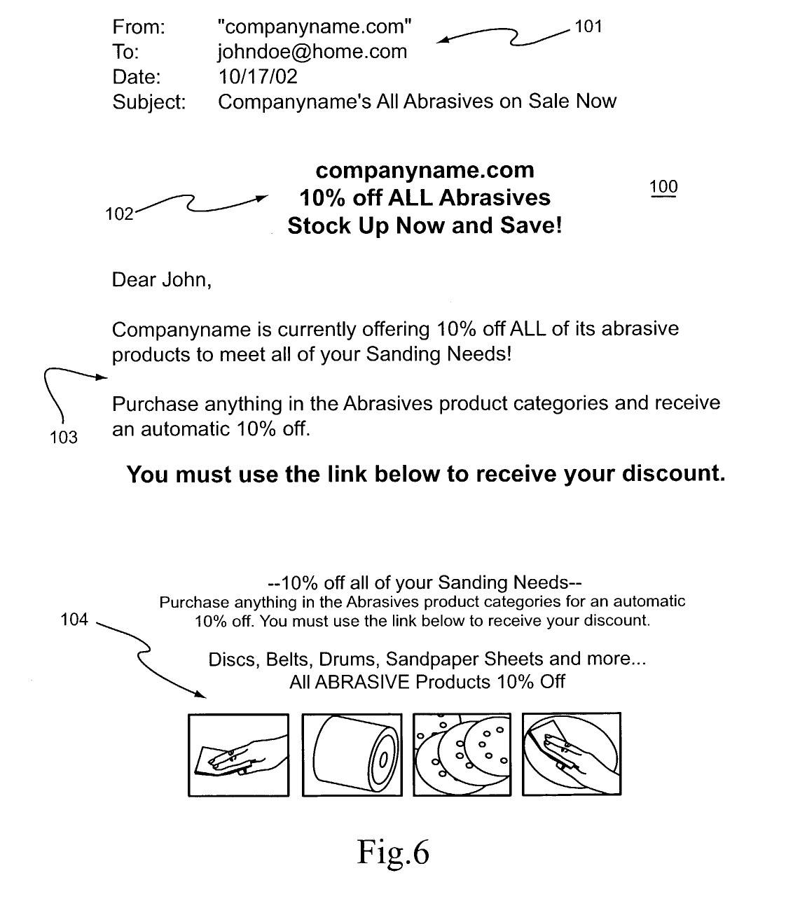

Alternatively, the selected names can be loaded into web server 32 whereupon a series of e-mails containing each name on the list and its corresponding e-mail address can be generated. Then, at step 25, the e-mails with a company website URL including a suffix based on the recipient's name is sent. One example of such an e-mail 10 is shown in FIG. 6.

Once the recipients receive the postcards or e-mails, it is anticipated that the postcards or e-mails will induce the recipients to log on to the identified server at step 28. For this purpose, the postcard may include information 64, such as a special promotional offer, that will be available to the recipient upon logging onto the website (not shown) corresponding to the URL 60 printed on the postcard 50. Similar promotional information 102 would be included in e-mail 100.

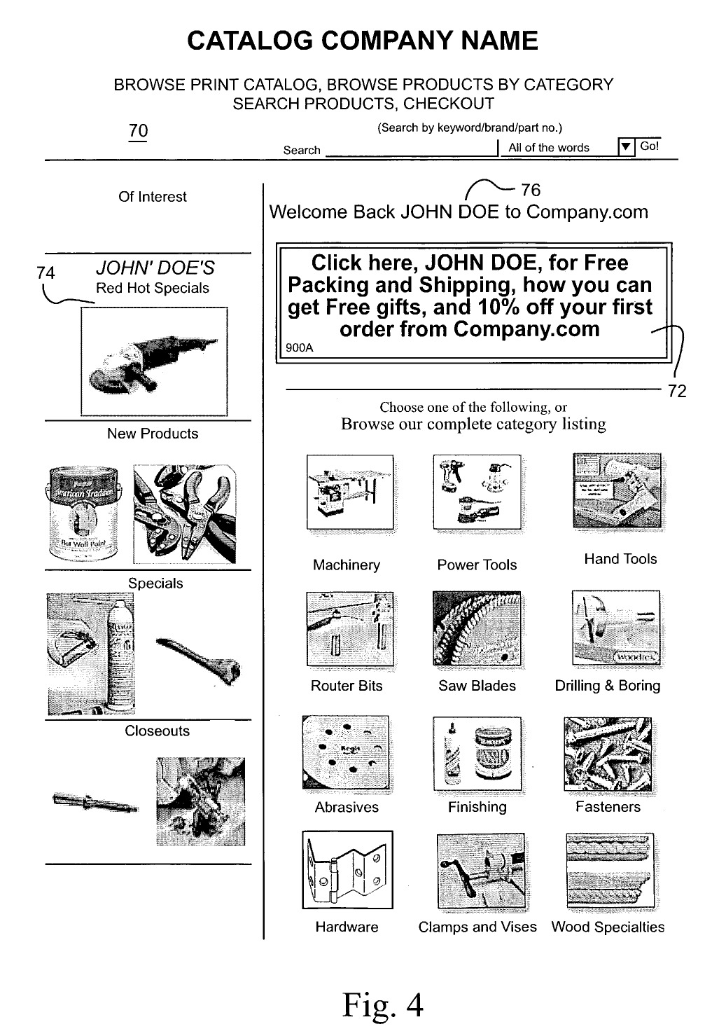

The software program used with the server 32 is designed to allow matching of the login names of the postcard recipients with the mailing names maintained in file 36 stored in server 32. This software includes, as noted at step 30 of FIG. 1, sound-alike software purchasable off the shelf, that allows matching of login names with stored names where there are instances of mis-keyed or misspelled name entries. If, at step 32, the customer login name is matched with a customer name stored in file 36 in server 32, at step 34 a special promotional offer page 70, as shown by way of example in FIG. 4, is presented on the server to the customer logging into the website. Preferably the promotional offer 72 or 74 is of such a nature that it induces the customer at step 36 to place an order with the company maintaining the website. Conversely, if a login customer's name does not match one of the names in file 36 stored in server 32, then at step 38 the standard welcome page (not shown) is presented to the customer logging into the website. The special offer page 70 presented at step 34 to a customer whose name matches one of the names stored in file server 36 in server 32 preferably will show the recipient's name, and may be unique only to that customer or a subgroup of customers included in the file 36 stored in server 32. The page 70 including the special offer 72 or 74 may also include one or more links 78 to the regular catalog or other merchandise or services offered at the standard welcome page.

There is no limit to the number of promotional mailings or e-mails that can be used to induce potential customers to log onto an e-commerce website and place an order. There is no limit to the size of the customer base that can be generated. One significant difficulty that arises is the overhead management that becomes necessary where the number of potential customers becomes extremely large so as to require a comparable number of custom web pages with promotional offers. It is possible to use the above-described marketing method with hundreds of thousands of customers. The difficulty of managing the large number of corresponding custom web pages arises every time each of the pages must be updated due to product changes or pricing changes. One solution to the overhead management difficulty for a very large number of custom web pages is to create the web pages on the fly each time a customer logs onto a company's web page.

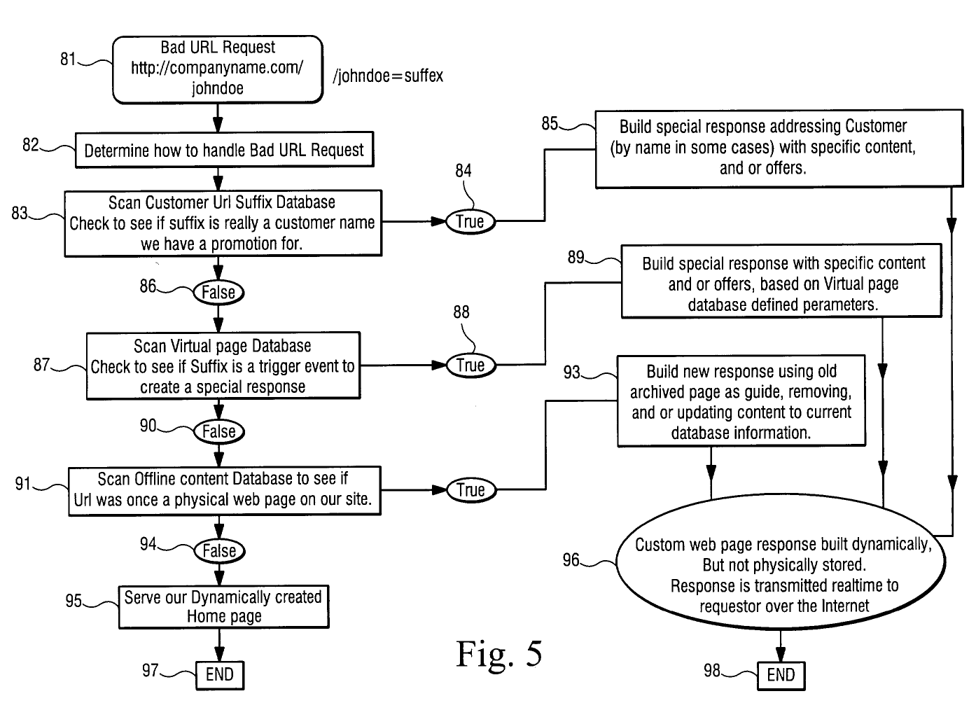

FIG. 5 is a flow chart showing the method of the present invention of building a custom web page in response to a URL suffix. As shown at step 81 of the flow chart of FIG. 5, server 32 receives a “bad URL request” that includes the URL for the company web page and a suffix that corresponds to the name of the person attempting to access a non-existent web page corresponding to the complete URL. In the embodiment shown in FIG. 5, the complete URL is http://companyname.com/johndoe, where johndoe is the suffix.

FIG. 6 is one embodiment of an e-mail 100 sent to a potential customer, John Doe, to entice the potential customer to visit a company's website and induce the potential customer to make a purchase at the website. E-mail 100 includes an address block 101 with the e-mail address for the company sending e-mail 100 and the e-mail address of the potential customer receiving it. The e-mail includes an announcement 102 reflecting a particular offer or sale or other promotional offering designed to entice the potential customer to visit the website of the company making the offering. Like postcard 50 shown in FIG. 3B, e-mail 100 can also include a brief message 103 to the customer explaining the offering and the need for the customer to use a hyperlink 104 to take advantage of the promotional offering.

When the customer types in the URL shown on postcard 50 in FIG. 3B or clicks on the hyperlink 104 as suggested in e-mail 100, server 32 shown in FIG. 1 receives the “bad URL request” identified in step 81 of FIG. 5. At step 82 of FIG. 5, server 32 determines how to handle the URL request. At step 83, server 32 scans a customer URL suffix data base 35 stored in server 32 to see whether the suffix “johndoe” is a customer name for which the company has a promotion. If at step 84 of FIG. 5 server 32 determines that the URL suffix is a customer name for which it has a promotion, then at step 85 server 32 builds a special response addressing the customer, by name in some cases, with specific content and/or offers. Preferably, this special response will be a web page that is sent by server 32 to the customer's personal computer 38 in response to the customer clicking on the URL 104 contained in email 100.

One embodiment of a custom web page 70 corresponding to postcard 50's URL is shown in FIG. 4. Custom web page 70 includes a special offer 72 directed to potential customer, John Doe. The special offer is designed to induce the customer to place an order at the web site.

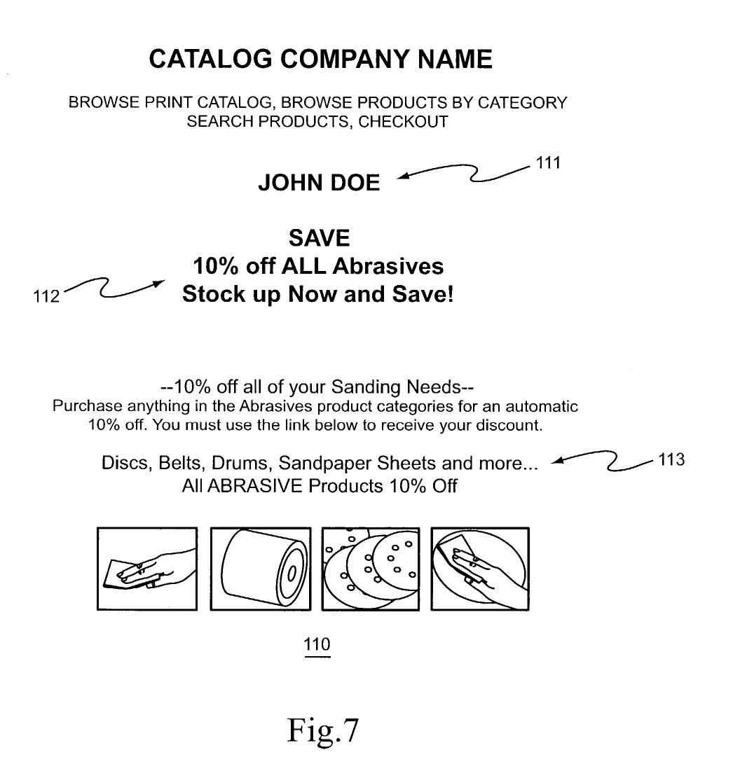

Another embodiment of a custom web page 110 corresponding to email 100 received by the potential customer, John Doe, is shown in FIG. 7. Custom web page 110 includes the customer's name 111 and a promotional offer 112 that corresponds to the promotional offer 102 included in e-mail 100. At step 96 of the flow chart of FIG. 5, custom web page 110 is built dynamically by accessing data from URL data base 35 corresponding to the suffix “johndoe”. At step 96, server 32 does not store custom web page 110 but transmits it over Internet 34 to requesting customer 32 at his personal computer 38 shown in FIG. 2.

If server 32 determines at step 86 of the flow chart of FIG. 5 that the URL suffix is not a customer name for which server 32 includes a promotion, then at step 87 server 32 scans a virtual page data base 37 stored in server 32 to determine whether the URL suffix is a trigger event to create a special response. If at step 88 server 32 determines that it is, then at step 89 it builds a special response with specific content and offers based on defined parameters stored in virtual page data base 37. Thereafter, at step 96, a custom web page response is dynamically built, but not physically stored and the response is again sent in real time over Internet 34 to the customer's computer 38. The custom web page response would be similar to the custom web page 110 shown in FIG. 7, but it would not include a customer name 111 as shown in web page 110 of FIG. 7.

If at step 90 of the flow chart 80 shown in FIG. 5, server 32 determines that the URL suffix “johndoe” is not found in the virtual page data base so as to be a trigger event to create a custom web page response, then at step 91, server 32 scans an off-line content data base 39 stored in server 32 to see if URL suffix “johndoe” was once a physical web page on the website serviced by server 32. If at step 92 server 32 determines that the URL suffix was once a physical web page on server 32's website, then at step 93 server 32 builds a new response using an old archived page responsive to the URL suffix as a guide, removing and/or updating content to include current data base information. Thereafter, again at step 96, a custom web page is dynamically built and not physically stored after which it is transmitted over Internet 34 to the user at his computer 38. Conversely, if at step 94, server 32 determines that the URL suffix was not once a physical web page on the website, server 32 provides to the user the dynamically-created home page corresponding to www.companyname.com, after which the server 32 ends its operation or its inquiry at step 97. Conversely, if server 32 does create a custom web page 110 in response to its inquiries at steps 83, 97 and 91, it then completes its processing at step 98.

The step 95 of serving a dynamically-created version of the home page for a company with the URL www.companyname.com can also occur in response to a request for the web page by an Internet search engine that is looking to “spider” the website to determine the content of the web page for ranking the web page in responses to Internet searches corresponding to a particular topic or subject area. The ranking done by Internet search engines often is based on the quality of the content contained on the web page and the relevance of the content of the web page to a particular search inquiry. By using the method of the present invention to build a virtual web page, a web page with extensive content can be created so that the web page, when “spidered”, is placed at the top of various search engine listings.

For example, if a company sells a product like ban saw blades, it is desirable for that company's web page to be well listed on search engines so that any potential customer who searches for ban saw blades sees that company on the search engine's listing for ban saw blade companies. Where a company ends up on the listing is called “ranking” on the search engine. Preferably, the company would want to be the first listing on the search engine list, if at all possible. To be ranked high on a list, sometime prior to a customer arriving on a particular search engine, the company's website for ban saw blades must be spidered by the search engine so that it can be ranked. The method of the present invention uses the URL suffix to create a virtual web page that would be called companyname.com/bansawblades.htm. According to the invention, this virtual page looks and feels like a real web page, but does not really exist. What does exist according to the present invention is a data base for the suffix “bansawblades.htm”. Any potential customer entering the website using that suffix causes the server 32 to create a page that is optimized for ban saw content. According to the method of the present invention, the customer is shown in the virtual web page the company's line of ban saw blades, parts, accessories and any other products that are relevant to ban saw blades so that when a search engine does spider the content of the web page it provides a high ranking for the web page in its search engine listings. The result is a listing typically at the top of search engine listings using the suffix method of the present invention.

One advantage of the present invention is a substantial reduction in the management overhead that would be necessary to oversee a large number of web pages that continually existed. If a large number of web pages continually existed, it would be necessary to employ sufficient people to maintain the web pages by keeping the content of the pages relevant and up-to-date with current pricing. Every time a company made a price change or increased or decreased its product line, all of the large number of web pages that were affected would have to be changed and updated. In the present invention, however, because the web pages responding to an inquiry by a potential customer are virtual web pages that are dynamically built, the web page is always based on current information such as pricing and product availability that is obtained from a data base that has been updated to reflect the current product information. Thus, if a price change is entered into the data base, the price change will be reflected on web pages that are built for customers as they arrive at the website with their own particular URL suffixes.

Although the present invention has been described in terms of a particular embodiment, it is not intended that the invention be limited to that embodiment. Modifications of the disclosed embodiment within the spirit of the invention will be apparent to those skilled in the art. The scope of the present invention is defined by the claims that follow:

What is claimed is:

1. A method of generating a custom web page used to induce a customer to place an order on an Internet website, the method comprising the steps of:
obtaining a list of persons;
providing a first device connected to the Internet;
storing the list of persons in the first device;
sending to each person included in the list first information for communicating with the first device over the Internet, second information designed to induce the person to contact the first device and place an order, and third information for generating and providing the person with a promotional offer;
providing at least one second device connected to the Internet to allow persons included in the list to contact the first device by transmitting the first information and the third information to the first device;
comparing the transmitted third information with a data base of stored information for generating promotional offers,
if the transmitted third information corresponds to any stored promotional offer information, generating from the data base a custom response including a selected promotional offer for the person contacting the first device, and
transmitting to the person's second device the custom response with the selected promotional offer.

2. The method of claim 1, wherein the first information is a uniform resource locator (“URL”) for the website and the third information is a suffix to the website URL.

3. The method of claim 2, wherein the suffix includes the name of the person receiving the first, second and third information.

4. The method of claim 3, wherein the suffix further includes descriptive information relating to the promotional offer.

5. The method of claim 1, wherein the step of comparing the third information with the data base of stored information for generating promotional offers comprises checking to see if the third information is either a customer name for which a promotional offer exists, a virtual page name corresponding to a promotional offer, or a prior physical web page.

6. The method of claim 1, wherein the step of generating from the data base a custom response including the selected promotional offer includes building the response with information stored in the first device relating to a product line selected for the promotional offer.

7. The method of claim 6, wherein the product line information includes pricing, identification numbers and descriptions of products included in the selected product line.

8. The method of claim 1, wherein the step of sending to each person the first, second, and third information comprises mailing the first, second, and third information to each person.

9. The method of claim 8, wherein a post card is used to perform the step of mailing the first, second, and third information to each person.

10. The method of claim 1, wherein the step of sending to each person the first, second, and third information comprises e-mailing the first, second, and third information to each person.

11. A method of generating a custom web page used to induce a customer to place an order on an Internet website, the method comprising the steps of:
obtaining a list of persons;
providing a first device connected to the Internet for servicing the website;
storing the list of persons in the first device;
sending to each person included in the list a uniform resource locator (“URL”) for the website, a promotional offer designed to induce the person to contact the website, and a suffix to the website URL for generating and providing the person with a promotional offer designed to induce the person to place an order at the website;
providing at least one second device connected to the Internet to allow persons included in the list to contact the first device by transmitting the URL and suffix to the first device;
comparing the transmitted suffix with a data base of stored suffixes used to generate a plurality of promotional offers,
if the transmitted suffix corresponds to any stored suffixes, generating a custom response including a selected promotional offer for the person contacting the first device, and
transmitting to the person's second device the custom response with the selected promotional offer.

12. The method of claim 11, wherein the suffix includes the name of the person receiving the URL and suffix.

13. The method of claim 12, wherein the suffix further includes descriptive information relating to the promotional offer.

14. The method of claim 11, wherein the step of comparing the transmitted suffix with a data base of stored suffixes comprises checking to see if the transmitted suffix is either a customer name for which a promotional offer exists, a virtual page name corresponding to a promotional offer, or corresponds a prior physical web page.

15. The method of claim 15, wherein the step of generating a custom response including the selected promotional offer includes building the response with information relating to a product line selected for the promotional offer.

16. The method of claim 15, wherein the product line information includes pricing, identification numbers and descriptions of products included in the selected product line.

17. The method of claim 11, wherein the step of sending to each person the URL and suffix comprises mailing the URL and suffix to each person.

18. The method of claim 17, wherein a post card is used to perform the step of mailing the URL and suffix to each person.

19. The method of claim 11, wherein the step of sending to each person the URL and suffix comprises emailing the URL and suffix to each person.

20. The method of claim 1, wherein the first device is a web server.

21. The method of claim 1, wherein the second devices include personal computers.

22. A system for generating a custom web page used to induce a customer to place an order on an Internet website, the system comprising:
means for obtaining a list of persons;
a first device connected to the Internet;
means for storing the list of persons in the first device;
means for sending to each person included in the list first information for communicating with the first device over the Internet, second information designed to induce the person to contact the first device and place an order, and third information for generating and providing the person with a promotional offer;
at least one second device connected to the Internet to allow persons included in the list to contact the first device by transmitting the first information and the third information to the first device;
means for comparing the transmitted third information with a data base of stored information for generating promotional offers,
means for generating from the data base a custom response including a selected promotional offer for the person contacting the first device, if the transmitted third information corresponds to any stored promotional offer information, and
means for transmitting to the person's second device the custom response with the selected promotional offer.

23. The system of claim 22, wherein the first information is a uniform resource locator (“URL”) for the website and the third information is a suffix to the website URL.

24. The system of claim 23, wherein the suffix includes the name of the person receiving the first, second and third information.

25. The system of claim 24, wherein the suffix further includes descriptive information relating to the promotional offer.

26. The system of claim 22, wherein the means for comparing the third information with the data base of stored information for generating promotional offers comprises means for checking to see if the third information is either a customer name for which a promotional offer exists, a virtual page name corresponding to a promotional offer, or a prior physical web page.

27. The system of claim 22, wherein the means for generating from the data base a custom response including the selected promotional offer includes means for building the response with information stored in the first device relating to a product line selected for the promotional offer.

28. The system of claim 27, wherein the product line information includes pricing, identification numbers and descriptions of products included in the selected product line.

29. The system of claim 22, wherein the means for sending to each person the first, second, and third information comprises means for mailing the first, second, and third information to each person.

30. The system of claim 29, wherein the means for mailing the first, second, and third information to each person is a post card.

31. The system of claim 29, wherein the means for sending to each person the first, second, and third information comprises means for e-mailing the first, second, and third information to each person.

32. The system of claim 22, wherein the first device is a web server.

33. The system of claim 1, wherein the second devices include personal computers.

34. A method of generating a custom product web page in response to a request from an Internet search engine to a website containing product information, the method comprising the steps of:
providing a first device connected to the Internet for servicing the website;
storing in the first device a data base of product information, the data base being updated in response to changes in the product information;
providing at least one second device connected to the Internet to allow the search engine to contact the first device by transmitting to the first device a uniform resource locator (“URL”) for the website and a suffix to the website URL for a selected product line;
comparing the transmitted suffix with a data base of stored suffixes used to generate custom product web pages for a plurality of product lines;
if the transmitted suffix corresponds to any stored suffixes, generating a custom product web pages for the selected product line; and
transmitting to the second device the custom product web pages for the selected product line.

35. The method of claim 34, wherein the suffix includes descriptive information relating to the selected product line.

36. The method of claim 34, wherein the step of comparing the transmitted suffix with a data base of stored suffixes comprises checking to see if the transmitted suffix is either a virtual page name for a product line included in the data base, or corresponds to a prior physical web page for the selected product line.

37. The method of claim 34, wherein the step of generating a custom product web page includes dynamically building the custom product web page with information relating to the selected product line.

38. The method of claim 37, wherein the product line information includes pricing, identification numbers, descriptions of products, and inventory for products included in the selected product line.

39. The method of claim 34, wherein the first device generates a custom product web page in response to an effort by the Internet search engine to spider a website regarding the selected product line.

40. The method of claim 39, wherein the Internet search engine ranks the website based on the custom product web page generated in response to the effort by the Internet search engine to spider the website.
